(19) United States
(12) Patent Application Publication
(10) Pub. No.: US 2021/0034079 A1
(43) Pub. Date: Feb. 4, 2021

(54) PERSONAL SPACE CREATION SYSTEM, PERSONAL SPACE CREATION METHOD, PERSONAL SPACE CREATION PROGRAM

(71) Applicant: Konica Minolta Inc., Tokyo (JP)

(72) Inventors: Masahiro YAMAGUCHI, Toyokawa-shi (JP); Daichi SUZUKI, Toyokawa-shi (JP); Hideo UEMURA, Tokyo (JP)

(21) Appl. No.: 16/921,516

(22) Filed: Jul. 6, 2020

(30) Foreign Application Priority Data
Jul. 29, 2019 (JP) 2019-138448

(51) Int. Cl. G05D 1/12; G05D 1/02; G05D 1/00; G10K 11/175

(52) U.S. Cl. CPC G05D 1/12; G10K 11/1752; G05D 1/0094; G05D 1/0223

(57) ABSTRACT

A personal space creation system includes: an autonomous mobile body having a part that blocks a line of sight of a user; and an information processor that controls behavior of the autonomous mobile body, the personal space creation system moving the autonomous mobile body in an open space to provide a personal space to the user, wherein the information processor includes a hardware processor that acquires position information and state information of at least a user as a target to which a blind effect is applied, sets an exclusive area and a free area in accordance with the position information and the state information of the user, and sets a blind spot near a boundary between the exclusive area and the free area, and creates and notifies the autonomous mobile body of a moving route through which the autonomous mobile body is moved to the blind spot.

The entire disclosure of Japanese patent Application No. 2019-138448, filed on Jul. 29, 2019, is incorporated herein by reference in its entirety.

### BACKGROUND

### Technological Field

The present invention relates to a personal space creation system, a personal space creation method, and a personal space creation program. In particular, the present invention relates to a personal space creation system for creating a personal space in an open space, a personal space creation method using such a personal space creation system, and a personal space creation program that runs in a device of such a personal space creation system.

### Description of the Related Art

A recent trend of open workplace requires optimization of layout of an open space such as co-working space according to intended use of individual users.

For example, JP 2016-001443 A discloses a meeting support system including a detection device that acquires information indicating execution conditions of a meeting, and a control device capable of communicating with the detection device. The control device includes storage means that stores multiple pieces of basic layout information set previously according to expected execution conditions of the meeting, and management information of multiple pieces of furniture used in the meeting, layout determination means that determines a layout that matches the acquired execution conditions and selects the furniture necessary for the determined layout from the management information of the furniture, on the basis of the information indicating the acquired execution conditions of the meeting acquired by the detector and the multiple pieces of the basic layout information stored in the storage means, and output means that outputs information indicating the determined layout and the selected furniture.

Meanwhile, mobile robots and mobile information devices that operate as partners or assistants to humans in the living environment of humans are also under development recently.

For example, JP 2008-246665 A discloses a behavior control apparatus used for a mobile body having a motion mechanism, including an acquisition unit that acquires position information indicating a position of a person and azimuth information indicating an orientation of the person for each one of one or more persons, a setting unit that sets an exclusive area for the person on the basis of the position of the person indicated by the position information by determining the shape of the exclusive area according to the orientation indicated by the azimuth information, a determination unit that determines whether there is information to be provided to the person from the mobile body, and a behavior determination unit that controls the motion mechanism of the mobile body such that the mobile body moves out of the exclusive area set for the person by the setting unit when the determination unit determines that there is no information to be provided to the person.

JP 2018-112775 A discloses an autonomous mobile robot including a robot body part, movement means that moves the robot body part to a destination point, detection means that detects situations of persons near the destination point, and control means that controls the movement means such that the robot body part approaches the person near the destination point through different moving routes depending on the situation of persons detected by the detection means.

A method of optimizing the layout of a co-working space according to the use of individual users is to create a space suitable for the purpose of use with an autonomous mobile body. Such a method can use the techniques including those disclosed in JP 2008-246665 A or JP 2018-112775 A, for controlling the behavior of the autonomous mobile body. On the other hand, it is necessary to customize the optimal space flexibly in the co-working space so that the users can concentrate on executing their work. Specifically, securing a personal space for each user is necessary, so that the user can work relaxed without feeling the eyes of others.

The size and shape of the personal space differ depending not only on whether the user is an individual or a group of persons, but also on the work contents, such as desk work, reading, talking, or the like. Prior art techniques, however, can only call up a predetermined layout stored in advance for a predetermined space, so that it has not been possible to create an optimal personal space for individual users.

### SUMMARY

The present invention has been made in view of the above problem, and it is an object of the present invention to provide a personal space creation system, a personal space creation method, and a personal space creation program capable of providing an appropriate personal space to individual users in an open space.

To achieve the abovementioned object, according to an aspect of the present invention, a personal space creation system reflecting one aspect of the present invention comprises: an autonomous mobile body having a part that blocks a line of sight of a user; and an information processor that controls behavior of the autonomous mobile body, the personal space creation system moving the autonomous mobile body in an open space to provide a personal space to the user, wherein the information processor includes a hardware processor that acquires position information and state information of at least a user as a target to which a blind effect is applied, sets an exclusive area and a free area in accordance with the position information and the state information of the user, and sets a blind spot near a boundary between the exclusive area and the free area, and creates and notifies the autonomous mobile body of a moving route through which the autonomous mobile body is moved to the blind spot.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention:

FIG. 1 is a block diagram illustrating a configuration of a personal space creation system according to an embodiment of the present invention;

FIG. 2 is a block diagram illustrating another configuration of the personal space creation system according to the embodiment of the present invention;

FIG. 3 is a flowchart illustrating an operation of an information processor according to the embodiment of the present invention;

FIG. 4 is a schematic diagram illustrating a personal space creation method according to the embodiment of the present invention;

FIG. 5 is a schematic diagram illustrating the personal space creation method according to the embodiment of the present invention;

FIG. 6 is a schematic diagram illustrating the personal space creation method according to the embodiment of the present invention;

FIG. 7 is an example of a user state table according to the embodiment of the present invention; and

FIG. 8 is a schematic diagram illustrating the personal space creation method according to the embodiment of the present invention.

### DETAILED DESCRIPTION OF EMBODIMENTS

Hereinafter, one or more embodiments of the present invention will be described with reference to the drawings. However, the scope of the invention is not limited to the disclosed embodiments.

As described in the Description of the Related art, the optimization of layout of the co-working space according to the use of individual users has been desired, and a method for creating a space suitable for the purpose of use using an autonomous mobile body has been proposed. On the other hand, it is necessary to customize the optimal space flexibly in the co-working space so that the users can concentrate on executing their work.

The size and shape of the personal space differ depending on whether the user is an individual or a group, but also on the work contents of the work as well. Prior art techniques, however, can only call up a predetermined layout stored in advance for a predetermined space, so that it has not been possible to create an optimal personal space for individual users.

In an embodiment of the present invention, therefore, a personal space is estimated for each user and an autonomous mobile body that can apply a blind effect is arranged at an appropriate position, thus creating the optimal personal space for each user.

Specifically, a personal space creation system includes an autonomous mobile body having a part that blocks the line of sight of a user, and an information processor that controls behavior of the autonomous mobile body, the personal space creation system moving the autonomous mobile body in the open space and providing a personal space to the user. The information processor acquires position information and state information of at least a user as a target to which the blind effect is applied, sets an exclusive area and a free area in accordance with the position information and the state information of the user, sets a blind spot near a boundary between the exclusive area and the free area, and creates and notifies the autonomous mobile body of a moving route through which the autonomous mobile body is moved to the blind spot.

Accordingly, even when more than one user is present in a limited space such as a co-working space, a personal space having an optimal size can be provided to each user, and the space is effectively used to the maximum.

### Embodiment

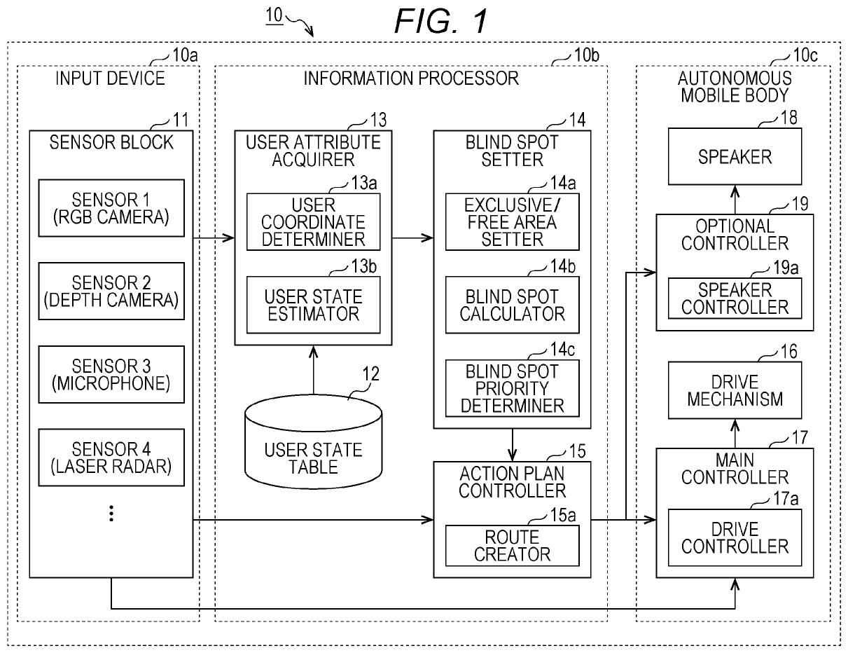

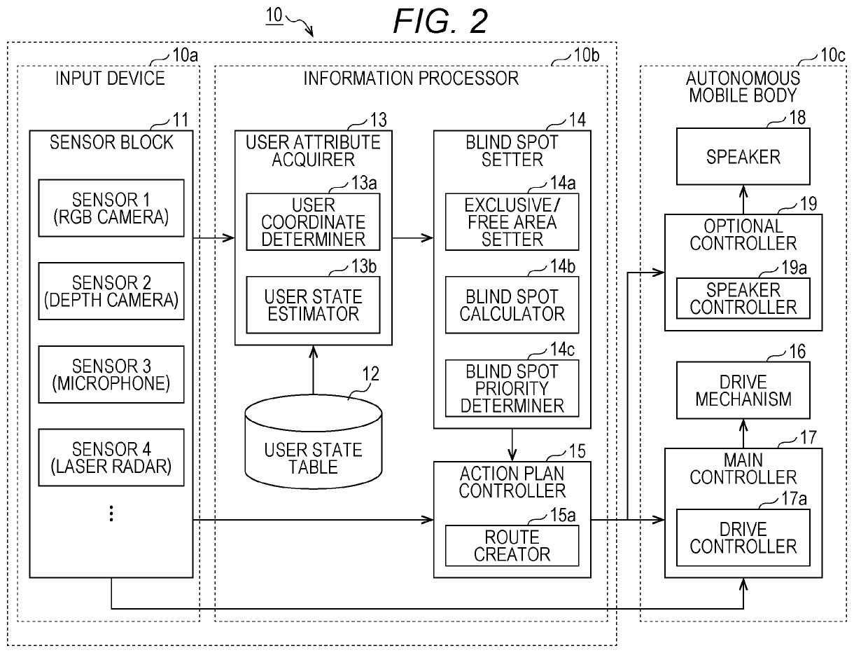

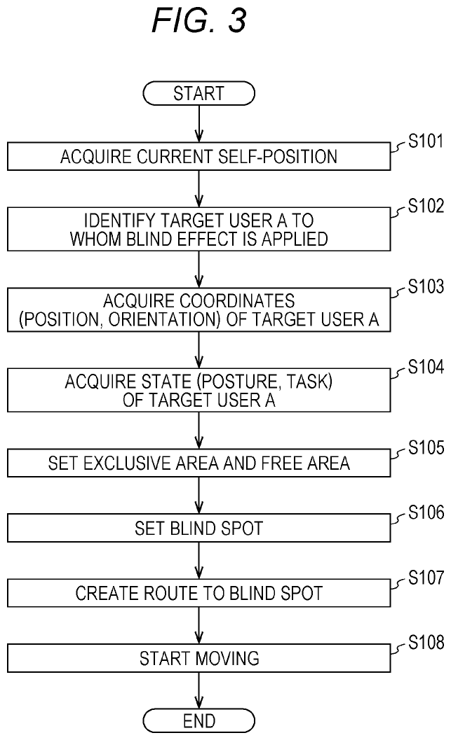

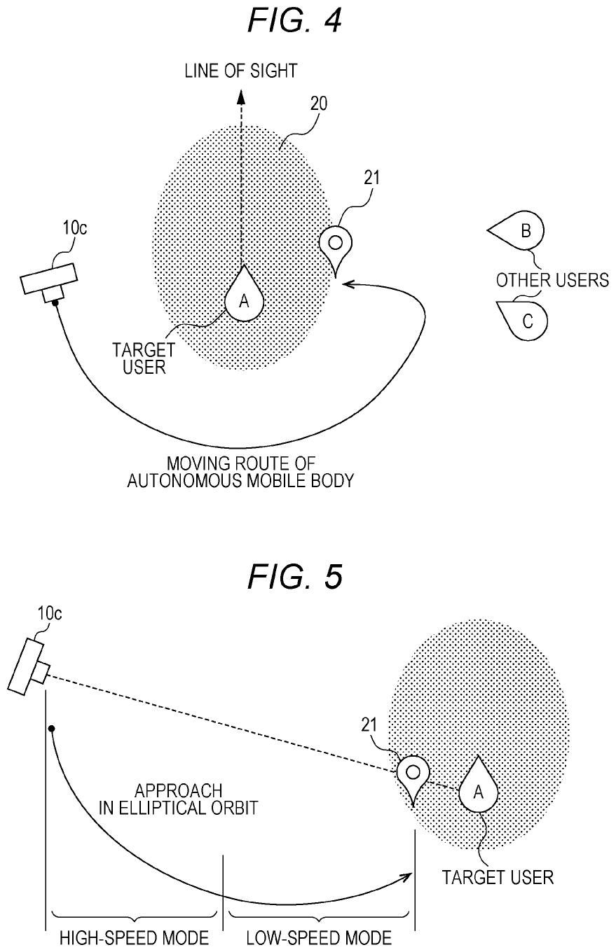

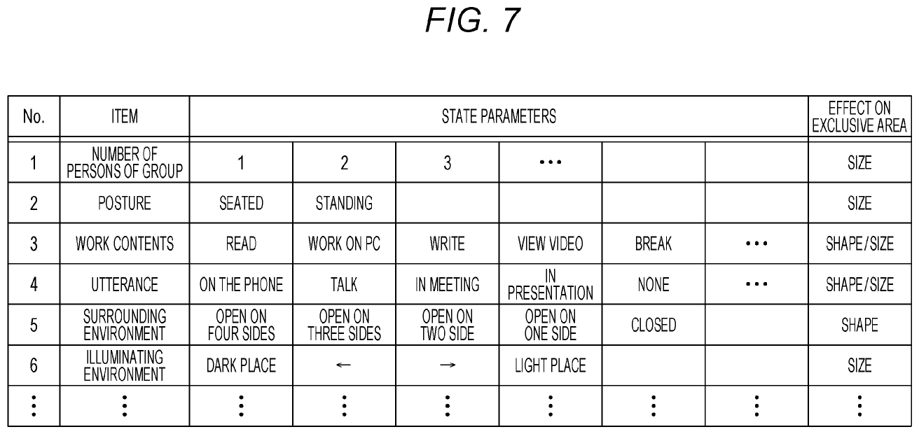

To detail the above-described embodiment of the present invention, a personal space creation system, a personal space creation method, and a personal space creation program according to an embodiment of the present invention are described with reference to FIGS. 1 to 8. FIGS. 1 and 2 are block diagrams illustrating the configuration of the personal space creation system of the present embodiment, and FIG. 3 is a flowchart illustrating the operation of the information processor of the present embodiment. FIGS. 4 to 6 and FIG. 8 are schematic diagrams illustrating the personal space creation method according to the present embodiment, and FIG. 7 is an example of a user state table according to the present embodiment.

A personal space creation system 10 of the present embodiment is a blindfold robot capable of autonomous movement (e.g., a houseplant, a partition, or a whiteboard) including an input device 10a, an information processor 10b, and an autonomous mobile body 10c. FIG. 1 illustrates the configuration including the input device 10a, the information processor 10b, and the autonomous mobile body 10c as an integrated part. Alternatively, as illustrated in FIG. 2, the input device 10a and the information processor 10b may be integrated, while the autonomous mobile body 10c may be configured as a separate device (or the input device 10a, the information processor 10b, and the autonomous mobile body 10c may be provided separately), and all devices are communicably connected with each other in a wire or wireless manner. Individual devices are described below with reference to the configuration of FIG. 1.

[Input Device]

The input device 10a includes a sensor block 11 and the like.

The sensor block 11 includes various sensors for detecting the position and state of the user, the position of the autonomous mobile body 10c, and the like. For example, an RGB camera for acquiring an image of a target, a depth camera for detecting the depth of the target, a microphone for detecting sound of the target, and a laser radar for detecting a distance to the target are included. The sensor block 11 may be disposed in the information processor 10b or the autonomous mobile body 10c, or at least partly disposed at an appropriate place of the open space (e.g., on the ceiling, wall, fixed fixture, or the like).

[Information Processor]

The information processor 10b is a computer device that controls the behavior of the autonomous mobile body 10c for creating a personal space, and includes a storage 12, a controller, and the like.

The storage 12 includes a hard disk drive (HDD) and a solid state drive (SSD), and stores various programs, information on processing functions of the information processor, a user state table which is described later, information of furniture layout in the open space, and the like.

The controller includes a central processing unit (CPU) and a memory such as a read only memory (ROM) or a random-access memory (RAM). The CPU includes a control program (including a personal space creation program which is described later) stored in the ROM or the storage 12, and deploys and executes the control program in the RAM to control the entire operation of the information processor 10b. This controller functions as a user attribute acquirer 13, a blind spot setter 14, an action plan controller 15, and the like.

The user attribute acquirer 13 acquires position information and state information of at least a user as a target to which a blind effect is applied. The user attribute acquirer 13 includes a user coordinate determiner 13a, a user state estimator 13b, and the like.

The user coordinate determiner 13a determines the coordinates of the user on the basis of information acquired from the RGB camera, the depth camera, the laser radar, and the like in the sensor block 11, and acquires position information (position, azimuth, and the like) of the user. For example, an image detected by the RGB camera is analyzed, and the position of the user in the open space is acquired by referring to the information of furniture layout in the open space. In addition, the image detected by the RGB camera is analyzed, and the position of the face is identified to obtain the azimuth (orientation) of the user.

The user state estimator 13b estimates the state of the user on the basis of information acquired from the RGB camera, the depth camera, the microphone, and the like in the sensor block 11, and acquires state information (posture, task state, and the like) of the user. Specifically, the posture of the user, task contents (behavior), an utterance state, the surrounding environment, the illuminating environment, and the like are acquired. For example, the image detected by the RGB camera is analyzed to identify the state of the body, and the posture of the user (e.g., whether the user is sitting or standing) is acquired. Also, the image detected by the RGB camera is analyzed to identify the movement of each part of the body, and the work contents (e.g., whether the user is reading, on PC work, writing, watching the video) are acquired. The voice detected by the microphone is analyzed, and the utterance state of the user (whether the user is on the phone, talking, meeting, or presenting) is acquired. The surrounding environment is detected by the RGB camera and analyzed to identify the wall, and the surrounding environment (e.g., open on all sides, open on two sides, open on one side, closed, or the like) is acquired. The image detected by the RGB camera is analyzed to identify a density, and the illuminating environment (e.g., dark place, bright place, or the like) is obtained.

The blind spot setter 14 sets an exclusive area and a free area on the basis of the position information and the state information of the user, and sets a blind spot near the boundary between the exclusive area and the free area. The blind spot setter 14 includes an exclusive/free area setter 14a, a blind spot calculator 14b, a blind spot priority order determiner 14c, and the like.

The exclusive/free area setter 14a sets an exclusive area and a free area on the basis of the position information and the state information of the user. For example, when the target to which the blind effect is applied is an individual, the exclusive area of the user is set on the basis of the orientation of the user identified from the position information and the task state of the user identified from the state information. At this time, the shape of the exclusive area can be determined from the orientation of the user, and the size of the exclusive area can be determined from the task state of the user. When the target to which the blind effect is applied is a group of persons, the task state of the group is set from the orientation of each user identified from the position information and the behavior of each user identified from the state information, and the exclusive area of the group is set on the basis of the position and orientation of each user identified from the position information and the task state of the group.

The blind spot calculator 14b sets a blind spot near the boundary between the exclusive area and the free area.

The blind spot priority order determiner 14c sets a plurality of candidate points for the blind spot, and determines the priority of each candidate point on the basis of at least one of the factors including a distance from the current position to each candidate point, the orientation, the posture, and the task state of the user, whether the current position is on the boundary between the exclusive area and the free area, whether the current position blocks the flow line of the person, the illuminating environment, and the surrounding environment. For example, a high priority may be assigned to a candidate point located in an extension of the direction in which the user faces or located on the boundary between the exclusive area and the free area. Alternatively, the flow line of the person in the open space is acquired, and the flow line history is classified incrementally into portions having a high flow line history and portions having a low flow line history. Then, the priority of each candidate point is determined on the basis of the flow line history (e.g., a high priority is assigned to a candidate point where the flow line history is low), or the flow line history is weighted in the direction of the flow line and the priority of each candidate point is determined on the basis of the weighted flow line history.

The action plan controller 15 creates a route (moving route) through which the autonomous mobile body 10c is moved to the blind spot, and notifies the autonomous mobile body 10c of the created route. The action plan controller 15 includes a route generator 15a and the like.

The route generator 15a estimates the line of sight of the user on the basis of the state information of the user, and creates the moving route from the current position to the blind spot so as not to pass ahead of the estimated line of sight. At this time, it is possible to create the moving route along an elliptical orbit having a major axis extending as a straight line between the current position and the blind spot.

When the autonomous mobile body 10c has two or more speed modes, the action plan controller 15 moves the autonomous mobile body 10c in a low-speed mode as the autonomous mobile body 10c approaches the blind spot. Alternatively, the action plan controller 15 moves the autonomous mobile body 10c in the low-speed mode when the autonomous mobile body 10c is located ahead of the line of sight of the user, while moving the autonomous mobile body 10c in a high-speed mode when the autonomous mobile body 10c is out of the line of sight of the user.

When the autonomous mobile body 10c includes a speaker, the action plan controller 15 can mask an environmental sound around the user by outputting a masking sound from the speaker. For example, the volume of the masking sound can be controlled according to the level of the environmental sound around the user, the frequency of the masking sound can be controlled according to the sound quality of the environmental sound around the user, the directivity of the masking sound can be controlled so that only the target user to whom the blind effect is applied can hear the sound, or the output timing of the masking sound can be controlled according to the operating noise of the autonomous mobile body 10c during moving.

The user attribute acquirer 13, the blind spot setter 14, and the action plan controller 15 may be implemented as hardware. Alternatively, the controller may be provided as a personal space creation program that functions as the user attribute acquirer 13, the blind spot setter 14, and the action plan controller 15, and the CPU executes such a personal space creation program.

[Autonomous Mobile Body]

The autonomous mobile body 10c is a device including a part that blocks the line of sight of the user (e.g., a houseplant, a partition, or a whiteboard), and includes a drive mechanism 16, a speaker 18, and a controller.

The drive mechanism 16 includes a motor, gears, shafts, wheels, and the like, and enables the autonomous mobile body 10c to move under the control of a drive controller which is described later.

The speaker 18 outputs a predetermined masking sound (sound for blocking the surrounding environmental sound from the user) under the control of a speaker controller which is described later.

The controller includes a CPU and a memory such as a ROM or a RAM, and functions as a main controller 17, an optional controller 19, and the like.

The main controller 17 includes a drive controller 17a and the like. The drive controller 17a controls the drive mechanism 16 according to the control signal of the action plan controller 15 so that the autonomous mobile body 10c moves along the route.

The optional controller 19 includes a speaker controller 19a and the like. The speaker controller 19a controls the speaker 18 according to the control signal of the action plan controller 15 so that a sound masking effect can be obtained by emitting sound or noise.

FIGS. 1 and 2 illustrate examples of the personal space creation system 10 of the present embodiment, and the configuration and control thereof can be changed as appropriate. For example, the sensor block 11 is included in the information processor 10b in FIGS. 1 and 2, but the sensor block 11 is not necessarily configured integrally with the information processor 10b if the controller of the information processor 10b can communicate with the sensor block 11.

In the above description, when the autonomous mobile body 10c has two or more speed modes, the action plan controller 15 of the information processor 10b transmits a control signal to the drive controller 17a of the autonomous mobile body 10c to control the speed of the autonomous mobile body 10c. Alternatively, the speed of the autonomous mobile body 10c may be controlled by the main controller 17 (drive controller 17a).

In the above description, the action plan controller 15 of the information processor 10b transmits a control signal to the speaker controller 19a of the autonomous mobile body 10c to control sound masking by the autonomous mobile body 10c. Alternatively, the controller 19 (speaker controller 19a) may cooperate with the main controller 17 to control the sound masking

When the autonomous mobile body 10c includes a display, the action plan controller 15 of the information processor 10b transmits a control signal to the optional controller 19 of the autonomous mobile body 10c to display an image (e.g., a healing image) on the display, or the optional controller 19 may cooperate with the main controller 17 to display an image on the display.

Hereinafter, a personal space creation method using the personal space creation system 10 of the above configuration is described. The CPU of the information processor 10b deploys and executes the personal space creation program stored in the ROM or the storage 12 in the RAM to execute respective processing steps illustrated in the flowchart of FIG. 3.

First, the controller (the blind spot setter 14) acquires the current self-position (or the position of the autonomous mobile body 10c in the case of the system configuration of FIG. 2) (S101). An acquiring method of the current self-position is not particularly limited. For example, information detected by various sensors of the sensor block 11 is analyzed (e.g., by analyzing the image acquired by the RGB camera and referring to the information of the furniture layout in the open space) to acquire the self-position of the open space.

Next, the controller (the user attribute acquirer 13) identifies the user A as a target to which the blind effect is applied (S102), and on the basis of information detected by various sensors of the sensor block 11, the coordinates (position, azimuth) (S103) of the target user and the state (posture, task) of the target user A are acquired (S104).

Next, the controller (blind spot setter 14) sets the exclusive area and the free area of the target user A on the basis of the position information and the state information of the target user A (S105). For example, the shape of the exclusive area is determined from the orientation of the target user A, and the size of the exclusive area is determined from the task state of the target user A.

Next, the controller (blind spot setter 14) sets the blind spot near the boundary between the exclusive area and the free area (S106). At this time, if there is a plurality of candidate blind spots, the priority of each candidate is determined. For example, the high priority is assigned to a candidate point located in an extension of the direction in which the target user A faces, a candidate point on the boundary between the exclusive area and the free area, or a candidate point located at the portions having a low flow line history.

Next, on the basis of the current self-position acquired in S101 and the blind spot set in S106, the controller (action plan controller 15) creates a route from the current self-position to the blind spot (S107) and notifies the autonomous mobile body 10c of the created route. For example, a route is created so as not to pass ahead of the line of sight of the target user A, or a route is created along an elliptical orbit having a major axis extending as a straight line between the self-position and the blind spot.

Next, the main controller 17 (drive controller 17a) of the autonomous mobile body 10c controls the drive mechanism 16 so that the autonomous mobile body 10c can move along the route created by the action plan controller 15, thus controlling the autonomous mobile body 10c and starting the move of the autonomous mobile body 10c (S108). At this time, if the autonomous mobile body 10c has two or more speed modes, the autonomous mobile body 10c switches to the low-speed mode as the autonomous mobile body 10c approaches the blind spot. If the autonomous mobile body 10c is located ahead of the line of sight of the user, the autonomous mobile body 10c switches to the low-speed mode. If the autonomous mobile body 10c is located out of the line of sight of the user, the autonomous mobile body 10c may be switched to the high-speed mode.

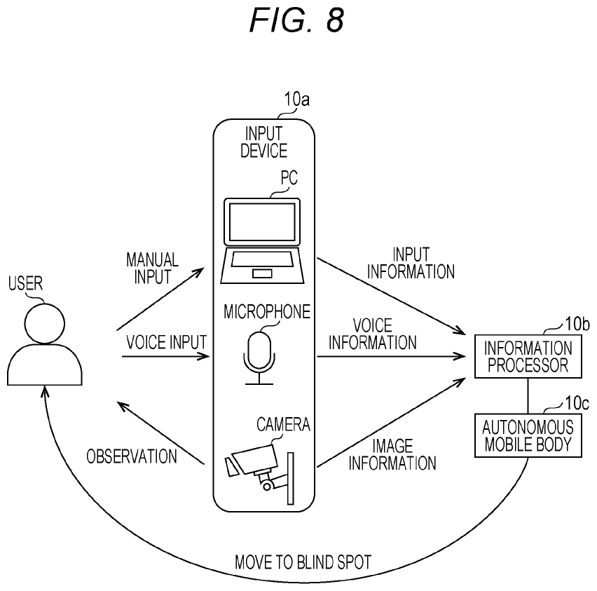

Hereinafter, the personal space creation method according to the present embodiment is described in detail with reference to FIGS. 4 to 6, the schematic diagrams of FIG. 8, and the user state table of FIG. 7.

FIG. 4 schematically illustrates a state in which a blind spot 21 is set on the boundary of the exclusive area 20 of the target user A to whom the blind effect is applied, and the autonomous mobile body 10c is moved to the blind spot 21.

First, the position information and the state information of the target user A are acquired using the information detected by various sensors of the sensor block 11, and the exclusive area 20 (hatched area of the drawing) is set on the basis of the acquired position information and state information of the target user A. For example, when the target user A is an individual, the exclusive area 20 of the target user A can be set on the basis of the orientation of the target user A identified from the position information and the task state of the target user A identified from the state information. At this time, the shape of the exclusive area 20 can be determined from the orientation of the target user A, and the size of the exclusive area 20 can be determined from the task state of the target user A. In the case where the target user A is a group, the task state of the group is set on the basis of the behavior of each user identified from the orientation and the position information of each user identified from the position information, and the exclusive area of the group can be set on the basis of the position and orientation of each user and task state of the group identified from the position information.

Next, the position information of other users (users B and C herein) is acquired, and the blind spot 21 is set at a position around the exclusive area 20 and a position blocking the line of sight of the target user A and other users B and C, who are not the target user A.

Next, a route for moving the autonomous mobile body 10c from the current position to the blind spot 21 is created. At this time, the line of sight of the target user A is estimated on the basis of the state information of the target user A, and the route from the current position to the blind spot is determined so as not to pass ahead of the estimated line of sight (the upper side of the drawing).

The autonomous mobile body 10c may be moved linearly from the current position to the blind spot 21, but if the autonomous mobile body 10c approaches the target user A linearly, the target user A becomes aware of the autonomous mobile body 10c and may possibly affect the work adversely. Therefore, as illustrated in FIG. 5, the autonomous mobile body 10c can approach along an elliptical orbit having a major axis extending as a straight line between the current position and the blind spot 21.

Further, the autonomous mobile body 10c may be moved at a constant speed from the current position to the blind spot 21, but if the autonomous mobile body 10c is moved at a high speed near the target user A, the target user A becomes aware of the autonomous mobile body 10c and may possibly affect the work adversely. On the other hand, it takes time to complete the moving if the autonomous mobile body 10c is moved from the current position to the blind spot 21 at a low speed. As illustrated in FIG. 5, therefore, two or more speed modes are provided to the autonomous mobile body 10c, so that the drive controller 17a can control the autonomous mobile body 10c to move in the low-speed mode as it approaches the blind spot 21. Although the speed of the autonomous mobile body 10c is changed according to the distance to the blind spot 21 herein, but it may also be possible to switch the speed mode such that the autonomous mobile body 10c moves in the low-speed mode when the autonomous mobile body 10c is located ahead of the line of sight of the target user A, while moving in the high-speed mode when being out of the line of sight of the target user A.

Further, FIGS. 4 and 5 illustrate the case where there is only one blind spot 21, but if there is a plurality of candidate points for the blind spot 21, the priority of each candidate point can be determined on the basis of at least one of the factors including the distance from the current position to each blind spot, the orientation, the posture, and the task state of the target user A, whether the current position is on the boundary between the exclusive area and the free area, whether the current position blocks the flow line of the person, the illuminating environment, and the surrounding environment.

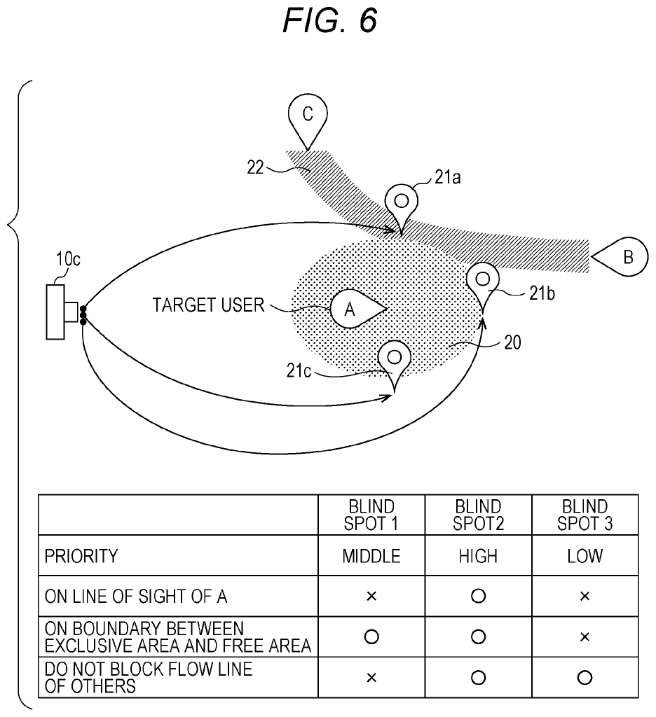

For example, as illustrated in FIG. 6, when there are three candidate blind spots 1 to 3, the high priority can be assigned to the candidate point if the candidate point is on the extension of the line of sight of the target user A or on the boundary between the exclusive area and the free area of the target user A. In addition, the flow line 22 of the person is acquired, and the flow line history is classified incrementally into portions having a high flow line history and portions having a low flow line history in stages. Then, the high priority can be assigned to the portions having the low flow line history (not disturbing the flow line of persons). In the case of FIG. 6, the blind spot 2 is on the line of sight of the target user A and on the boundary between the exclusive area and the free area, and does not disturb the flow line of the person, thus having the high priority.

In FIGS. 4 to 6, the case where there is only one target user is described. In the case where there is one or more target users (group), a user state table as illustrated in FIG. 7 is created and stored in the storage 12 or the like. With reference to such a user state table, the task state of the group is set on the basis of the orientation and behavior of each target user and, from the acquired position and orientation of each target user and the task state of the group, the exclusive area of the group can be set.

Further, the control for moving the autonomous mobile body 10c to the blind spot has been described in the above, but even if the autonomous mobile body 10c can block the line of sight of others by the autonomous mobile body 10c, various sounds may reach the target user and affect the work adversely. In such a case, the work environment of the target user can be improved by a sound masking effect by the autonomous mobile body 10c emitting sound or noise.

In this case, the optional controller 19 (speaker controller 19a) of the autonomous mobile body 10c may control the speaker 18 to output a predetermined sound. At this time, the volume of the masking sound can be controlled according to the level of the environmental sound around the user, the frequency of the masking sound can be controlled according to the quality of the sound of the environmental sound around the user, the directivity of the masking sound can be controlled so that only the target user can hear the sound, or the output timing of the masking sound can be controlled according to an operating noise of the autonomous mobile body 10c during moving. Further, when the autonomous mobile body 10c includes a display, a predetermined image is displayed on the display, so that the work environment of the target user can be improved.

In the above description, the information processor 10b observes the user with the RGB camera or the depth camera of the sensor block 11 to determine the need of the blind, and when it is determined that the blind is needed, the autonomous mobile body 10c is moved. Alternatively, the user can instruct the moving of the autonomous mobile body 10c. For example, as illustrated in FIG. 8, the user can input voice to a microphone or the like of the sensor block 11, and move the autonomous mobile body 10c on the basis of the voice information. Alternatively, the user can manually input a command by operating the personal computer, and move the autonomous mobile body 10c on the basis of the input information.

As described above, in the situation where there is more than one user in a limited space such as a co-working space, after estimating the personal space for each user and disposing the autonomous mobile body 10c to which the blind effect at the appropriate position, it is possible to provide the personal space of the optimal size to each user, thus utilizing the space as efficiently as possible.

It is noted that the present invention is not limited to the above-described embodiment, and the configuration and control thereof can be appropriately changed without departing from the spirit of the present invention.

For example, in the above-described embodiment, the houseplant, the partition, or the whiteboard is illustrated as the example of the autonomous mobile body 10c, but the personal space creation method of the embodiment of the present invention can similarly be applied to any other article capable of being disposed in the open space and securing the personal space provided as the autonomous mobile body 10c.

The present invention can be used for the personal space creation system for creating a personal space in a rental space, the personal space creation method using the personal space creation system, the personal space creation program that operates on a device of the personal space creation system, and the storage medium having the personal space creation program stored therein.

Although embodiments of the present invention have been described and illustrated in detail, the disclosed embodiments are made for purposes of illustration and example only and not limitation. The scope of the present invention should be interpreted by terms of the appended claims.

What is claimed is:

1. A personal space creation system, comprising:
an autonomous mobile body having a part that blocks a line of sight of a user; and
an information processor that controls behavior of the autonomous mobile body, the personal space creation system moving the autonomous mobile body in an open space to provide a personal space to the user, wherein
the information processor includes
a hardware processor that acquires position information and state information of at least a user as a target to which a blind effect is applied,
sets an exclusive area and a free area in accordance with the position information and the state information of the user, and sets a blind spot near a boundary between the exclusive area and the free area, and
creates and notifies the autonomous mobile body of a moving route through which the autonomous mobile body is moved to the blind spot.

2. The personal space creation system according to claim 1, wherein
when the object to which the blind effect is applied is an individual, the hardware processor sets the exclusive area of the user in accordance with an orientation of the user identified from the position information and a task state of the user identified from the state information.

3. The personal space creation system according to claim 2, wherein
the hardware processor determines a shape of the exclusive area from the orientation of the user and determines a size of the exclusive area from the task state of the user.

4. The personal space creation system according to claim 1, wherein
when the target to which the blind effect is applied is a group, the hardware processor sets a task state of the group from an orientation of each user identified from the position information and the behavior of each user identified from the state information, and sets the exclusive area of the group in accordance with the position and the orientation of each user identified from the position information and the task state of the group.

5. The personal space creation system according to claim 1, wherein
the hardware processor sets a plurality of candidate points for the blind spot, and determines priority of each candidate point in accordance with at least one of factors including a distance from a current position to each candidate point, an orientation of the target, a posture of the target, a task state of the target, whether the target is on the boundary between the exclusive area and the free area, whether the target blocks a flow line of a person, an illuminating environment, and a surrounding environment.

6. The personal space creation system according to claim 5, wherein
the hardware processor increases the priority of a candidate point located in an extension of a direction in which the target faces.

7. The personal space creation system according to claim 5, wherein
the hardware processor increases the priority of the candidate point located on the boundary between the exclusive area and the free area.

8. The personal space creation system according to claim 5, wherein
the hardware processor acquires the flow line of a person in the open space, classifies flow line history incrementally into portions having a large number of flow line histories and portions having a small number of flow line histories, and determines the priority of each candidate point in accordance with the flow line history.

9. The personal space creation system according to claim 8, wherein
the hardware processor weights the flow line history in the direction of the flow line, and determines the priority of each candidate point in accordance with the weighted flow line history.

10. The personal space creation system according to claim 1, wherein
the hardware processor estimates the line of sight of the target in accordance with the state information of the target, and creates the moving route that avoids passing ahead of the estimated line of sight.

11. The personal space creation system according to claim 1, wherein
the hardware processor creates the moving route along an elliptical orbit having a major axis extending as a straight line between the current position and the blind spot.

12. The personal space creation system according to claim 1, wherein
the autonomous mobile body has two or more speed modes, and
the hardware processor moves the autonomous mobile body in a low-speed mode as the autonomous mobile body approaches the blind spot.

13. The personal space creation system according to claim 12, wherein
the hardware processor moves the autonomous mobile body in the low-speed mode when the autonomous mobile body is located ahead of the line of sight of the target, while moving the autonomous mobile body in a high-speed mode when the autonomous mobile body is out of the line of sight of the target.

14. The personal space creation system according to claim 1, wherein
the autonomous mobile body includes a speaker, and
the hardware processor outputs a sound from the speaker to mask an environmental sound around the target.

15. The personal space creation system according to claim 14, wherein
the hardware processor controls the volume of a masking sound according to the level of the environmental sound around the target, or the frequency of the masking sound according to quality of the quality of the sound of the environmental sound around the target.

16. The personal space creation system according to claim 14, wherein
the hardware processor controls the directivity of the masking sound to allow only the target to hear the sound.

17. The personal space creation system according to claim 14, wherein
the hardware processor controls output timing of the masking sound according to operating noise during moving of the autonomous mobile body.

18. The personal space creation system according to claim 1, wherein
the information processor is installed on the autonomous mobile body.

19. A personal space creation method of a personal space creation system including an autonomous mobile body having a part that blocks a line of sight of a user, and an information processor that controls behavior of the autonomous mobile body, the personal space creation system moving the autonomous mobile body in an open space and providing a personal space to the user,
the personal space creation method causes the information processor to execute:
acquiring position information and state information of at least a user as a target to which the blind effect is applied;
setting an exclusive area and a free area in accordance with the position information and the state information of the user;
setting a blind spot near a boundary between the exclusive area and the free area; and
creating and notifying the autonomous mobile body of a moving route through which the autonomous mobile body is moved to the blind spot.

20. A non-transitory recording medium storing a computer readable personal space creation program of a personal space creation system including an autonomous mobile body having a part that blocks the line of sight of a user, and an information processor that controls behavior of the autonomous mobile body, the personal space creation system moving the autonomous mobile body in an open space and providing a personal space to the user,
the personal space creation program causes the information processor to execute:
acquiring position information and state information of at least a user as a target to which the blind effect is applied;
setting an exclusive area and a free area in accordance with the position information and the state information of the user;
setting a blind spot near a boundary between the exclusive area and the free area; and
creating and notifying the autonomous mobile body of a moving route through which the autonomous mobile body is moved to the blind spot.
